(19) United States
(12) Patent Application Publication
(10) Pub. No.: US 2026/0270689 A1
(43) Pub. Date: Sep. 10, 2026

(54) RECONSTRUCTING INFORMATION LOST IN TRANSFERRING DATA OVER A BLOCK ERROR-INTRODUCING RADIO CHANNEL, AND RELATED DEVICES, METHODS AND COMPUTER PROGRAMS

(71) Applicant: Nokia Solutions and Networks Oy, Espoo (FI)

(72) Inventors: Akshay JAIN, Espoo (FI); Karthik UPADHYA, Espoo (FI); Traian ABRUDAN, Espoo (FI); Dani Johannes KORPI, Espoo (FI); Mikko Aleksi UUSITALO, Espoo (FI)

(21) Appl. No.: 19/162,463

(22) PCT Filed: Mar. 9, 2023
(86) PCT No.: PCT/EP2023/055998

§ 371 Date: Sep. 5, 2025

(51) Int. Cl. H04W 8/30; H04L 41/16; H04W 64/00

(52) U.S. Cl. CPC H04W 8/30; H04L 41/16; H04W 64/00

(57) ABSTRACT

Devices, methods and computer programs for reconstructing information lost in transferring data over a block error introducing radio channel are disclosed. At least some example embodiments may allow more power efficient way of transferring such data with lower latency, while still maintaining a faithful transmission of information.

### TECHNICAL FIELD

The disclosure relates generally to communications and, more particularly but not exclusively, to reconstructing information lost in transferring data over a block error-introducing radio channel, as well as related devices, methods and computer programs.

### BACKGROUND

At least in some situations, internet of things (IoT) may allow ubiquitous connectivity and utility via third generation partnership project (3GPP) based networks.

Typically, IoT devices are energy and computation constrained. Hence, energy efficiency is of importance, particularly for future sixth generation (6G) networks. Usually, conventional communication systems aim to recover errors at lower layers via hybrid automatic repeat requests (HARQs) and retransmissions at radio link control (RLC) and transport layers. However, if used with IoT devices, these conventional retransmissions may consume additional energy within the IoT devices.

Furthermore, these retransmissions may also lead to additional delays. For example, considering a block error rate (BLER) of 10% before a HARQ stage, every retransmission may be in the range of about a 3-4 millisecond (ms) delay. Such a delay may eventually impact the quality of service.

Accordingly, at least in some situations, there may be a need for making transfer of data over a block error-introducing radio channel more power efficient with lower latency, while still maintaining a faithful transmission of information.

### SUMMARY

The scope of protection sought for various example embodiments of the invention is set out by the independent claims. The example embodiments and features, if any, described in this specification that do not fall under the scope of the independent claims are to be interpreted as examples useful for understanding various example embodiments of the invention.

An example embodiment of an apparatus comprises at least one processor, and at least one memory storing instructions that, when executed by the at least one processor, cause the apparatus at least to perform obtaining data produced by at least one wireless data producing device. The produced data has been transferred over a block error-introducing radio channel, thereby causing information to be lost from the produced data. The instructions, when executed by the at least one processor, further cause the apparatus at least to perform reconstructing the lost information. The reconstruction of the lost information comprises applying a neural network, NN, to the obtained data. The NN is executable to utilize at least one of temporal or spatial correlation information related to the produced data in the reconstruction of the lost information.

In an example embodiment, alternatively or in addition to the above-described example embodiments, the instructions, when executed by the at least one processor, further cause the apparatus to perform obtaining location information of the introduced block errors. The NN is further executable to utilize the obtained location information of the introduced block errors in the reconstruction of the lost information.

In an example embodiment, alternatively or in addition to the above-described example embodiments, the instructions, when executed by the at least one processor, further cause the apparatus to perform evaluating accuracy of the performed reconstruction of the lost information. In response to the evaluated accuracy falling below a given threshold or rising above the given threshold, the instructions, when executed by the at least one processor, further cause the apparatus to perform instructing a network node device responsible for forwarding the produced data to increase or decrease, respectively, a number of reforwardings of the produced data.

In an example embodiment, alternatively or in addition to the above-described example embodiments, the instructions, when executed by the at least one processor, further cause the apparatus to perform the instructing of the network node device to increase or decrease the of the reforwardings independently for at least one of a transport layer, a radio link control layer, or a medium access control layer of the radio channel.

In an example embodiment, alternatively or in addition to the above-described example embodiments, the instructions, when executed by the at least one processor, further cause the apparatus to perform the evaluating of the accuracy of the performed reconstruction of the lost information based on a calculated error metric between predicted data and actual data.

In an example embodiment, alternatively or in addition to the above-described example embodiments, the instructions, when executed by the at least one processor, further cause the apparatus to perform the obtaining of the location information of the introduced block errors from the network node device responsible for forwarding the produced data.

In an example embodiment, alternatively or in addition to the above-described example embodiments, the apparatus comprises a network edge device or a network cloud device obtaining the produced data in one or more uplink transmissions from the network node device responsible for forwarding the produced data.

In an example embodiment, alternatively or in addition to the above-described example embodiments, the apparatus comprises a client device obtaining the produced data in one or more downlink transmissions from the network node device responsible for forwarding the produced data.

In an example embodiment, alternatively or in addition to the above-described example embodiments, the instructions, when executed by the at least one processor, further cause the apparatus to perform training the NN by applying a loss function, in order to maximize prediction accuracy in the reconstruction of the lost information.

In an example embodiment, alternatively or in addition to the above-described example embodiments, the produced data comprises at least one of images, videos, time series data, or patterns.

In an example embodiment, alternatively or in addition to the above-described example embodiments, the NN comprises at least one of a convolutional NN, a recurrent NN, a long short-term memory, a multi layer perceptron, a fully connected NN, a transformer NN, a graph NN, or a reinforcement learning based NN.

In an example embodiment, alternatively or in addition to the above-described example embodiments, the radio channel comprises a cellular radio channel.

In an example embodiment, alternatively or in addition to the above-described example embodiments, the at least one wireless data producing device comprises an internet of things, IoT, device.

An example embodiment of a method comprises obtaining, by an apparatus, data produced by at least one wireless data producing device, the produced data having been transferred over a block error-introducing radio channel, thereby causing information to be lost from the produced data. The method further comprises reconstructing, by the apparatus, the lost information. The reconstruction of the lost information comprises applying a neural network, NN, to the obtained data. The NN is executable to utilize at least one of temporal or spatial correlation information related to the produced data in the reconstruction of the lost information.

In an example embodiment, alternatively or in addition to the above-described example embodiments, the method further comprises obtaining, by the apparatus, location information of the introduced block errors. The NN is further executable to utilize the obtained location information of the introduced block errors in the reconstruction of the lost information.

In an example embodiment, alternatively or in addition to the above-described example embodiments, the method further comprises evaluating, by the apparatus, accuracy of the performed reconstruction of the lost information. In response to the evaluated accuracy falling below a given threshold or rising above the given threshold, the method further comprises instructing, by the apparatus, a network node device responsible for forwarding the produced data to increase or decrease, respectively, a number of reforwardings of the produced data.

In an example embodiment, alternatively or in addition to the above-described example embodiments, the instructing of the network node device to increase or decrease the number of the reforwardings is performed independently for at least one of a transport layer, a radio link control layer, or a medium access control layer of the radio channel.

In an example embodiment, alternatively or in addition to the above-described example embodiments, the evaluating of the accuracy of the performed reconstruction of the lost information is performed based on a calculated error metric between predicted data and actual data.

In an example embodiment, alternatively or in addition to the above-described example embodiments, the location information is obtained from the network node device responsible for forwarding the produced data.

In an example embodiment, alternatively or in addition to the above-described example embodiments, the apparatus comprises a network edge device or a network cloud device obtaining the produced data in one or more uplink transmissions from the network node device responsible for forwarding the produced data.

In an example embodiment, alternatively or in addition to the above-described example embodiments, the apparatus comprises a client device obtaining the produced data in one or more downlink transmissions from the network node device responsible for forwarding the produced data.

In an example embodiment, alternatively or in addition to the above-described example embodiments, the method further comprises training the NN by applying a loss function, in order to maximize prediction accuracy in the reconstruction of the lost information.

In an example embodiment, alternatively or in addition to the above-described example embodiments, the produced data comprises at least one of images, videos, time series data, or patterns.

In an example embodiment, alternatively or in addition to the above-described example embodiments, the NN comprises at least one of a convolutional NN, a recurrent NN, a long short-term memory, a multi layer perceptron, a fully connected NN, a transformer NN, a graph NN, or a reinforcement learning based NN.

In an example embodiment, alternatively or in addition to the above-described example embodiments, the radio channel comprises a cellular radio channel.

In an example embodiment, alternatively or in addition to the above-described example embodiments, the at least one wireless data producing device comprises an internet of things, IoT, device.

An example embodiment of a computer program comprises instructions for causing an apparatus to perform at least the following: obtaining data produced by at least one wireless data producing device, the produced data having been transferred over a block error-introducing radio channel, thereby causing information to be lost from the produced data; and reconstructing the lost information. The reconstruction of the lost information comprises applying a neural network, NN, to the obtained data. The NN is executable to utilize at least one of temporal or spatial correlation information related to the produced data in the reconstruction of the lost information.

### DESCRIPTION OF THE DRAWINGS

The accompanying drawings, which are included to provide a further understanding of the embodiments and constitute a part of this specification, illustrate embodiments and together with the description help to explain the principles of the embodiments. In the drawings:

FIG. 1 shows an example embodiment of the subject matter described herein illustrating an example system, where various embodiments of the present disclosure may be implemented;

FIG. 2 shows an example embodiment of the subject matter described herein illustrating an apparatus;

FIG. 3 shows an example embodiment of the subject matter described herein illustrating a disclosed neural network with a processing block, input, output and signaling channels;

FIG. 4 shows an example embodiment of the subject matter described herein a disclosed neural network reusing a protocol stack;

FIG. 5 shows an example embodiment of the subject matter described herein illustrating a disclosed neural network training phase;

FIG. 6 shows an example embodiment of the subject matter described herein illustrating a disclosed neural network inference phase;

FIG. 7 shows an example embodiment of the subject matter described herein illustrating signaling between lower protocol layers and a disclosed neural network;

FIG. 8 shows another example embodiment of the subject matter described herein illustrating signaling between lower protocol layers and a disclosed neural network; and

FIG. 9 shows an example embodiment of the subject matter described herein illustrating a method.

Like reference numerals are used to designate like parts in the accompanying drawings.

### DETAILED DESCRIPTION

Reference will now be made in detail to embodiments, examples of which are illustrated in the accompanying drawings. The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

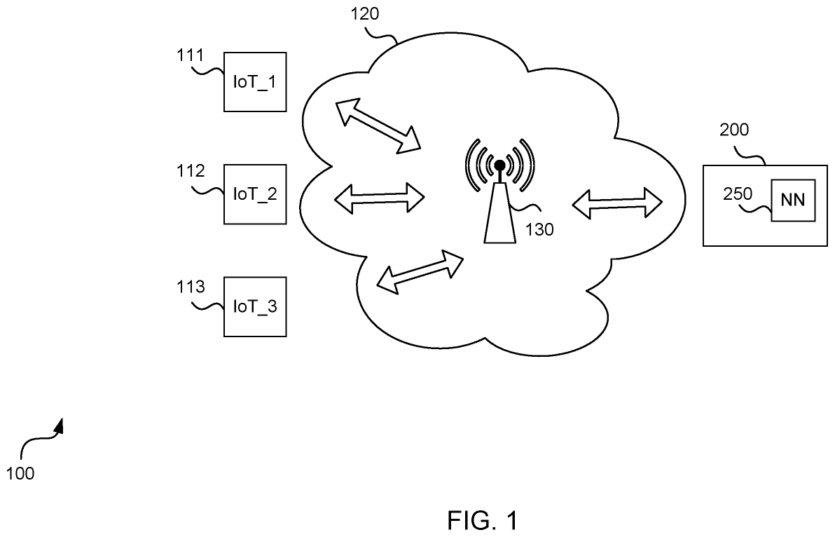

FIG. 1 illustrates an example system 100, where various embodiments of the present disclosure may be implemented. The system 100 may comprise a fifth generation (5G) new radio (NR) network or a network beyond 5G wireless networks. An example representation of the system 100 is shown depicting wireless data producing devices 111-113, a block error-introducing radio channel 120, a network node device 130, and an apparatus 200 including a neural network (NN) 250.

The network node device 130 may comprise a base station. The base station may include, e.g., any device suitable for providing an air interface for client devices (including the wireless data producing devices 111-113) to connect to a wireless network via wireless transmissions.

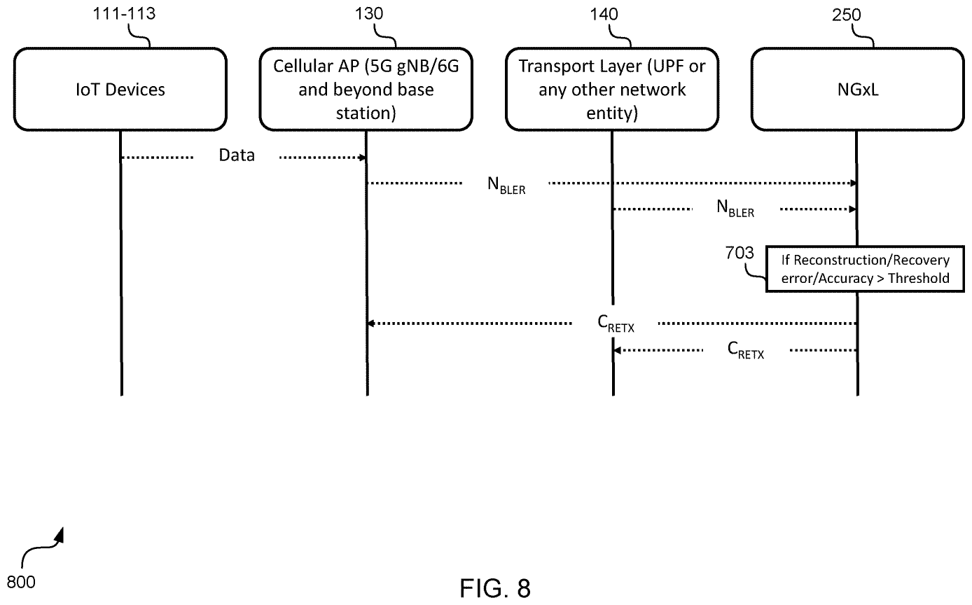

The system 100 may further comprise network elements/units/devices not shown in FIG. 1, such as a user plane function (UPF) 140 shown in FIG. 8.

At least in some embodiments, the network of FIG. 1 may comprise one or more massive machine-to-machine (M2M) network(s), massive machine type communications (mMTC) network(s), internet of things (IoT) network(s), industrial internet-ofthings (IIoT) network(s), enhanced mobile broadband (eMBB) network(s), ultra-reliable low-latency communication (URLLC) network(s), and/or the like. In other words, the network of FIG. 1 may be configured to serve diverse service types and/or use cases, and it may logically be seen as comprising one or more networks.

In the following, various example embodiments will be discussed. At least some of these example embodiments described herein may allow the apparatus 200 to reconstruct information lost in transferring data from the wireless data producing devices 111-113 over the block error-introducing radio channel 120.

At least some of the example embodiments described herein may allow a neural network-based approach to reduce repetitions/retransmissions. Reconstruction/recovery of the lost information is done by exploiting inherent temporal and spatial correlation in IoT data. The neural network may be located, e.g., on a central cloud or an edge server.

At least some of the example embodiments described herein may allow enhancing a BLER before the HARQ by 6%-7%, thus reducing the workload of lower protocol layers as well as reducing the energy consumption of the IoT devices themselves.

At least some of the example embodiments described herein may allow recovering/reconstructing lost information without the need for excessive repetitions/retransmissions. Consequently, at least some of the example embodiments described herein may allow reducing the load on lower layers for error recovery and also the energy requirements for the IoT devices. Moreover, at least some of the example embodiments described herein may allow facilitating transmission at even lower powers for the IoT devices.

At least some of the example embodiments described herein may not necessitate provision of the neural network on the IoT device itself. Accordingly, at least some of the example embodiments described herein may provide additional energy efficiency for the IoT devices.

At least some of the example embodiments described herein may not require large changes in the communication protocol stack. At least in some of the example embodiments described herein, implementation may require very little extra signalling, thus making the disclosure suitable for 6G and beyond.

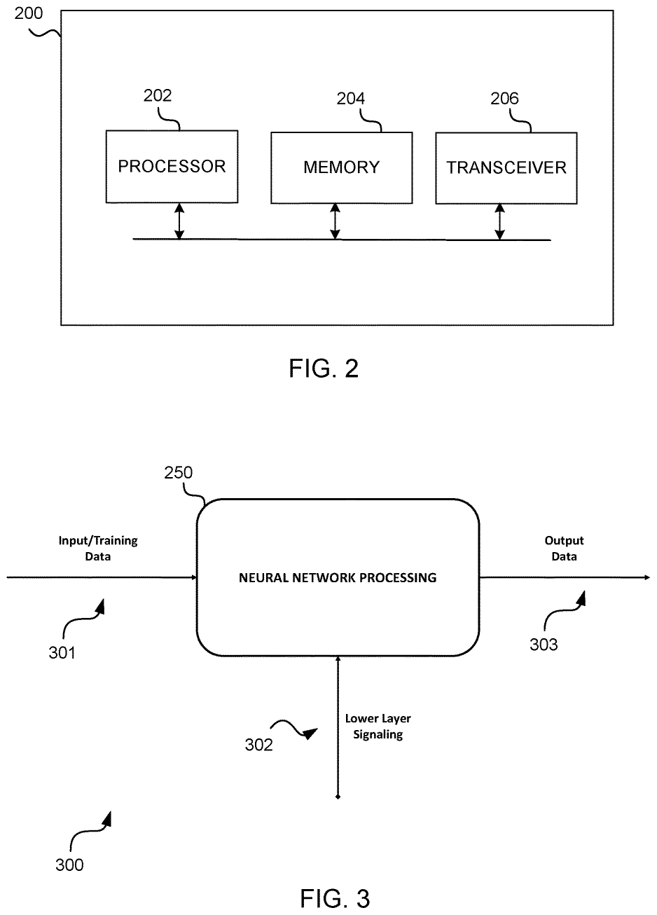

FIG. 2 is a block diagram of the apparatus 200, in accordance with an example embodiment.

The apparatus 200 comprises one or more processors 202 and one or more memories 204 that comprise computer program code. The apparatus 200 may also include other elements, such as a transceiver 206 configured to enable the apparatus 200 to transmit and/or receive information to/from other devices, as well as other elements not shown in FIG. 2. In one example, the apparatus 200 may use the transceiver 206 to transmit or receive signaling information and data in accordance with at least one cellular communication protocol. The transceiver 206 may be configured to provide at least one wireless radio connection, such as for example a 3GPP mobile broadband connection (e.g., 5G or beyond). The transceiver 206 may comprise, or be configured to be coupled to, at least one antenna to transmit and/or receive radio frequency signals.

Although the apparatus 200 is depicted to include only one processor 202, the apparatus 200 may include more processors. In an embodiment, the memory 204 is capable of storing instructions, such as an operating system and/or various applications. Furthermore, the memory 204 may include a storage that may be used to store, e.g., at least some of the information and data used in the disclosed embodiments.

Furthermore, the processor 202 is capable of executing the stored instructions. In an embodiment, the processor 202 may be embodied as a multi-core processor, a single core processor, or a combination of one or more multi-core processors and one or more single core processors. For example, the processor 202 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, a neural network (NN) chip, an artificial intelligence (AI) tensor processing unit (TPU), a neural processing unit (NPU), or the like. In an embodiment, the processor 202 may be configured to execute hardcoded functionality. In an embodiment, the processor 202 is embodied as an executor of software instructions, wherein the instructions may specifically configure the processor 202 to perform the algorithms and/or operations described herein when the instructions are executed.

The memory 204 may be embodied as one or more volatile memory devices, one or more non-volatile memory devices, and/or a combination of one or more volatile memory devices and nonvolatile memory devices. For example, the memory 204 may be embodied as semiconductor memories (such as mask ROM, PROM (programmable ROM), EPROM (erasable PROM), flash ROM, RAM (random access memory), etc.).

When executed by the at least one processor 202, instructions stored in the at least one memory 204 cause the apparatus 200 at least to perform obtaining data produced by the at least one wireless data producing device 111-113. For example, the produced (e.g., collected and/or generated) data may comprise images, videos, time series data, and/or patterns. At least in some embodiments, the at least one wireless data producing device 111-113 may comprise an internet of things (IoT) device. At least in some embodiments, the IoT devices may comprise cellular network capable IoT devices.

The produced data has been transferred over a block error-introducing radio channel 120, thereby causing information to be lost from the produced data. For example, the radio channel 120 may comprise a cellular radio channel.

The instructions, when executed by the at least one processor 202, further cause the apparatus 200 at least to perform reconstructing the lost information.

The reconstruction of the lost information comprises applying a neural network (NN) 250 to the obtained data. The NN 250 is executable to utilize temporal and/or spatial correlation information related to the produced data in the reconstruction of the lost information. For example, the NN 250 may comprise a convolutional NN, a recurrent NN, a long short-term memory, a multi layer perceptron, a fully connected NN, a transformer NN, a graph NN, and/or a reinforcement learning based NN.

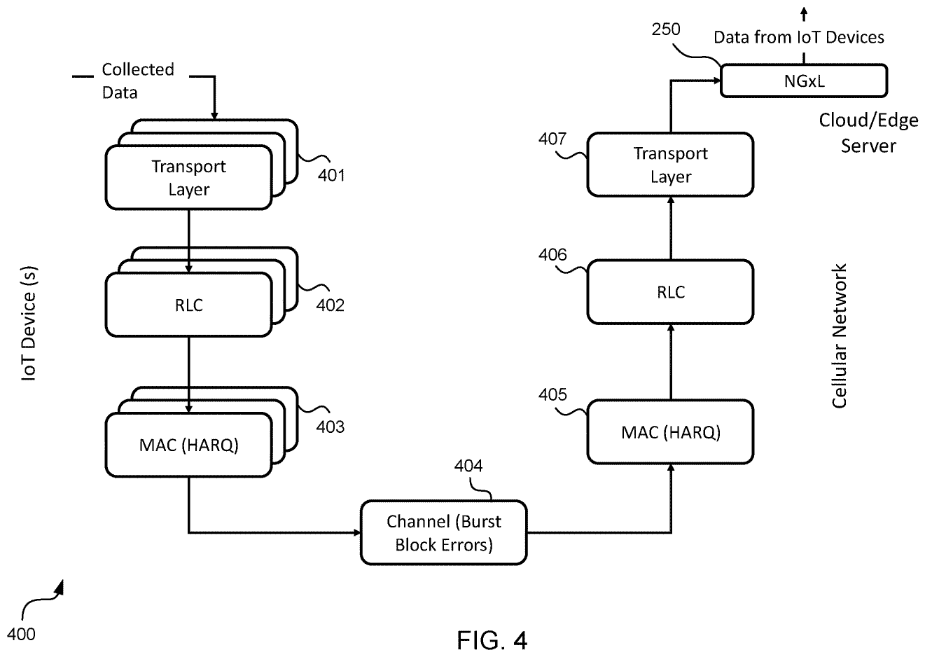

In other words and as illustrated in diagram 400 of FIG. 4, the data collected from the IoT devices 111-113 may pass through a transport layer 401, a radio link control (RLC) layer 402, and a hybrid automatic repeat request (HARQ) layer 403. From there, the data may be transmitted to a receiver via a bursty channel 404. The received data may be transmitted upstream via the various layers 405-407 within the protocol stack, as shown in diagram 400. It is to be noted that diagram 400 only shows layers that employ some form of error recovery via correction or retransmissions. The data may then be passed on to the disclosed NN 250, which is a trained NN that may be placed, e.g., in an edge server or a centralized data center. The NN 250 may perform data recovery/reconstruction by utilizing, e.g., the temporal and spatial information that it may have learnt during a training process.

In regard to the temporal and spatial correlation aspect of the data that the NN 250 uses to its benefit, e.g., subsequent video frames may not have large differences/changes and may thus be defined as having temporal correlation, whereas a temperature in a closed area at different points may also be similar and hence it may be defined as having spatial correlation. Another example of spatial correlation may include pixels in an image, wherein any given pixel may have a strong correlation with its surrounding pixels. Thus, if for instance some video frames, or values of temperature at some points, or image pixels are received correctly and the rest are in error/lost, the missing information may still be reconstructed/recovered because this lost information is likely similar to what has been received correctly. Thus, the NN 250 may first be trained on a dataset comprising corrupted data as well as correct labels/predicted values with which NN 250 may learn to classify/predict the information as accurately as possible in the presence of errors/losses.

At least in some embodiments, the instructions, when executed by the at least one processor 202, may further cause the apparatus 200 to perform obtaining location information of the introduced block errors. For example, the instructions, when executed by the at least one processor 202, may further cause the apparatus 200 to perform the obtaining of the location information of the introduced block errors from a network node device 130 responsible for forwarding the produced data. The NN 250 may further be executable to utilize the obtained location information of the introduced block errors in the reconstruction of the lost information.

At least in some embodiments, the instructions, when executed by the at least one processor 202, may further cause the apparatus 200 to perform evaluating accuracy of the performed reconstruction of the lost information. For example, the instructions, when executed by the at least one processor 202, may further cause the apparatus 200 to perform the evaluating of the accuracy of the performed reconstruction of the lost information based on a calculated error metric between predicted data and actual data.

In response to the evaluated accuracy falling below a given threshold or rising above the given threshold, the instructions, when executed by the at least one processor 202, may further cause the apparatus 200 to perform instructing the network node device 130 responsible for forwarding the produced data to increase or decrease, respectively, a number of reforwardings of the produced data. For example, the instructions, when executed by the at least one processor 202, may further cause the apparatus 200 to perform the instructing of the network node device 130 to increase or decrease the number of the reforwardings independently for at least one of: a transport layer of the radio channel 120, a radio link control layer of the radio channel 120, or a medium access control layer of the radio channel 120.

At least in some embodiments, the apparatus 200 may comprise a network edge device or a network cloud device obtaining the produced data in one or more uplink transmissions from the network node device 130 responsible for forwarding the produced data. Alternatively, the apparatus 200 may comprise a client device obtaining the produced data in one or more downlink transmissions from the network node device 130 responsible for forwarding the produced data.

At least in some embodiments, the instructions, when executed by the at least one processor 202, may further cause the apparatus 200 to perform training the NN 250 by applying a loss function, in order to maximize prediction accuracy in the reconstruction of the lost information.

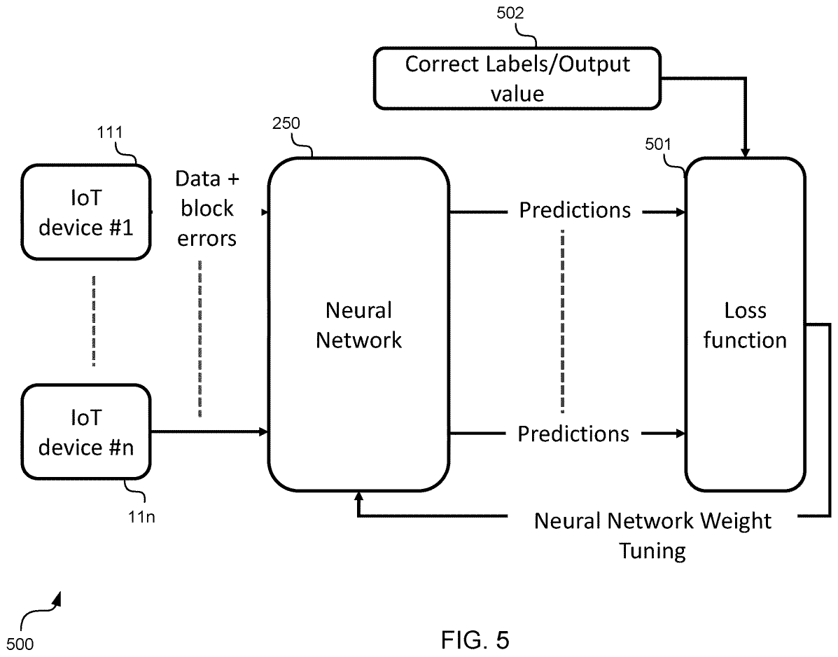

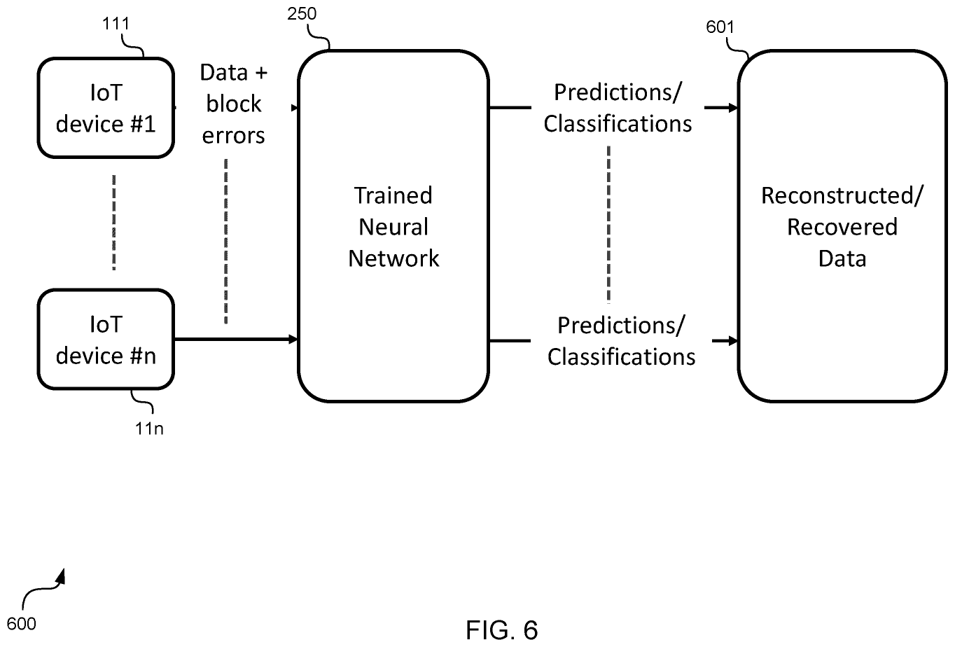

In other words, the NN 250 may first be trained with a dataset that contains actual data with block errors and correct labels/values 502. The NN 250 may then learn to minimize its prediction/classification accuracy using the aforementioned dataset. To perform this minimization, a loss function 501 (such as a mean squared error) may be computed, and then correspondingly the NN 250 weights (parameters) may recursively be tuned. This is known as a training phase and it is illustrated in diagram 500 of FIG. 5. After the NN 250, during the training phase, has learnt the correlation information inherently present within the data, the NN 250 may perform prediction/classification while taking the data with block errors as input. Using these predicted/classified values the NN 250 may be able to reconstruct/recover (block 601) the transmitted data. This is known as an operation/inference phase, and it is illustrated in diagram 600 of FIG. 6.

Diagram 300 of FIG. 3 further illustrates operation of the NN 250. For the training process, the NN 250 may collect data from the input data stream 301 at first, and then perform offline learning. After enough training data is gathered, the NN 250 may be trained and then it may be utilized for data recovery/reconstruction. The type of NNs 250 that can be utilized depending on the type of application/data that the IoT devices 111-113 collect and transmit may include, e.g.:

| Application | Type of neural network |
|---|---|
| Images | Convolutional neural network (CNN) |
| Time series data | Recurrent neural network (RNN), Long short |
| | term memory (LSTM) |
| Basic patterns | Multi-layer perceptron/fully connected |
| | (FC/MLP NN) |
| Videos | Combination of CNN and LSTM or graph neural |
| | networks (GNNs) |

Additionally, to specify the location of the block errors in the incoming stream of data as well as to inform the lower layers for adjusting their error recovery mechanisms a signaling channel may be provided between the NN 250 and lower layers.

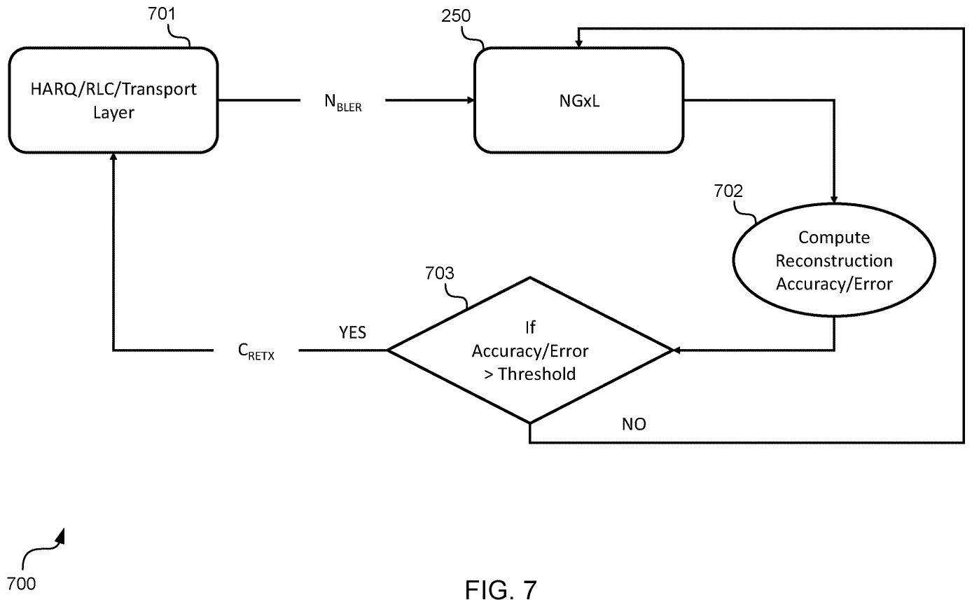

Diagrams 700 of FIG. 7 and 800 of FIG. 8 illustrate examples of such a signaling channel and procedure. For example, the lower layers 701 may inform the NN 250 of the position of the block errors (N_{BLER}). The location of these block errors may be provided to the NN 250 so that the NN 250 may distinguish between the correct blocks of data and the incorrect blocks of data. After reconstruction/recovery of the incoming data stream, the error/accuracy for this process may be computed at operation 702. This may be done by means of computing the error, such as a squared error or a mean absolute error, between the predicted data/labels and the true data/labels. If the error/accuracy rises above/drops below a certain specified threshold (operation 703), an indication to increase/decrease the number of retransmissions (C_{Retx}) may provided to the lower layers 701. The exact value of C_{Retx} may be implementation specific, and it may be controlled independently for each lower layer. Thus, the disclosure allows a context aware approach, in which a cross-layer feedback loop may assist in adjusting the error recovery at lower layers 701 such that the transmission time energy efficiency may be further optimized.

Alternative to such a feedback loop, predefined BLER thresholds may be specified so that the lower layers may themselves adjust the number of retransmissions without needing specific feedback. Furthermore, both the thresholds as well as the increase/decrease in the number of retransmission parameters (C_{Retx}) may be chosen based on application requirements.

At least in some embodiments, the disclosure may be utilized to exploit any possible correlation in information across a protocol stack on any device type and not just that which exists at the application level in IoT devices.

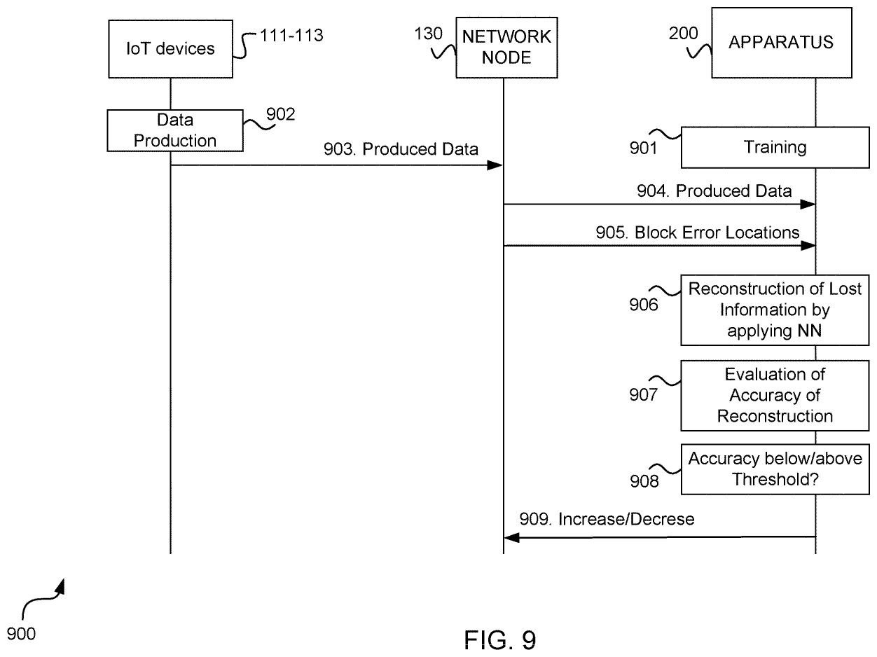

FIG. 9 illustrates an example signaling diagram of a method 900, in accordance with an example embodiment.

At optional operation 901, the apparatus 200 may train the NN 250 by applying the loss function, in order to maximize the prediction accuracy in the reconstruction of the lost information, as described above in more detail.

At optional operation 902, the at least one wireless data producing device 111-113 may produce data, such as images, videos, time series data, and/or patterns, as described above in more detail.

At optional operation 903, the at least one wireless data producing device 111-113 may transmit the produced data to the network node device 130. Further at optional operation 903, the network node device 130 may receive the produced data.

At operation 904, the apparatus 200 obtains the produced data, e.g., via the network node device 130 forwarding the produced data to the apparatus 200. As described above in more detail, the produced data was transferred over the block error-introducing radio channel 120, thereby causing information to be lost from the produced data.

At optional operation 905, the apparatus 200 may obtain the location information of the introduced block errors from the network node device 130.

It is to be noted that even though in the example of FIG. 9 operation 901 is performed before operation 902, alternatively operation 901 may be performed after any of operations 902-905, for example.

At operation 906, the apparatus 200 reconstructs the lost information. As described above in more detail, the reconstructing 906 of the lost information comprises applying the NN 250 to the obtained data. The NN 250 is executable to utilize temporal and/or spatial correlation information related to the produced data (and the obtained location information of the introduced block errors available) in when the reconstruction of the lost information.

At optional operation 907, the apparatus 200 may evaluate the accuracy of the performed reconstruction of the lost information.

At optional operation 908, the apparatus 200 may determine whether the evaluated accuracy falls below the given threshold or rises above the given threshold.

At optional operation 909, the apparatus 200 may instruct the network node device 130 to increase the number of reforwardings of the produced data in response to the evaluated accuracy falling below the given threshold. Alternatively, at optional operation 909, the apparatus 200 may instruct the network node device 130 to decrease the number of reforwardings of the produced data in response to the evaluated accuracy rising above the given threshold.

The method 900 may be performed at least partially by the apparatus 200 of FIG. 2. The operations 901, 904-909 can, for example, be performed by the at least one processor 202 and the at least one memory 204. Further features of the method 900 directly result from the functionalities and parameters of the apparatus 200, and thus are not repeated here. The method 900 can be performed by computer program(s).

The apparatus 200 may comprise means for performing at least one method described herein. In one example, the means may comprise the at least one processor 202, and the at least one memory 204 storing instructions that, when executed by the at least one processor, cause the apparatus 200 to perform the method.

The functionality described herein can be performed, at least in part, by one or more computer program product components such as software components. According to an embodiment, the apparatus 200 may comprise a processor or processor circuitry, such as for example a microcontroller, configured by the program code when executed to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Programspecific Standard Products (ASSPs), System-on-a-chip systems (SOCs), Complex Programmable Logic Devices (CPLDs), Tensor Processing Units (TPUs), and Graphics Processing Units (GPUS).

Any range or device value given herein may be extended or altered without losing the effect sought. Also, any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the embodiments described above may be combined with aspects of any of the other embodiments described to form further embodiments without losing the effect sought.

The term ‘comprising’ is used herein to mean including the method, blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. An apparatus, comprising:
at least one processor; and
at least one memory storing instructions that, when executed by the at least one processor, cause the apparatus at least to perform:
obtaining data produced by at least one wireless data producing device, the produced data having been transferred over a block error-introducing radio channel, thereby causing information to be lost from the produced data; and
reconstructing the lost information,
wherein the reconstruction of the lost information comprises applying a neural network to the obtained data, the neural network being executable to utilize at least one of temporal or spatial correlation information related to the produced data in the reconstruction of the lost information.

2. The apparatus according to claim 1, wherein the instructions, when executed by the at least one processor, further cause the apparatus to perform:
obtaining location information of the introduced block errors,
wherein the neural network is further executable to utilize the obtained location information of the introduced block errors in the reconstruction of the lost information.

3. The apparatus according to claim 1, wherein the instructions, when executed by the at least one processor, further cause the apparatus to perform:
evaluating accuracy of the performed reconstruction of the lost information; and
in response to the evaluated accuracy falling below a given threshold or rising above the given threshold, instructing a network node device responsible for forwarding the produced data to increase or decrease, respectively, a number of reforwardings of the produced data.

4. The apparatus according to claim 3, wherein the instructions, when executed by the at least one processor, further cause the apparatus to perform the instructing of the network node device to increase or decrease the number of the reforwardings independently for at least one of a transport layer, a radio link control layer, or a medium access control layer of the radio channel.

5. The apparatus according to claim 3, wherein the instructions, when executed by the at least one processor, further cause the apparatus to perform the evaluating of the accuracy of the performed reconstruction of the lost information based on a calculated error metric between predicted data and actual data.

6. The apparatus according to claim 3, wherein the instructions, when executed by the at least one processor, further cause the apparatus to perform the obtaining of the location information of the introduced block errors from the network node device responsible for forwarding the produced data.

7. The apparatus according to claim 3, wherein the apparatus comprises a network edge device or a network cloud device obtaining the produced data in one or more uplink transmissions from the network node device responsible for forwarding the produced data.

8. The apparatus according to claim 3, wherein the apparatus comprises a client device obtaining the produced data in one or more downlink transmissions from the network node device responsible for forwarding the produced data.

9. The apparatus according to claim 1, wherein the instructions, when executed by the at least one processor, further cause the apparatus to perform training the neural network by applying a loss function, in order to maximize prediction accuracy in the reconstruction of the lost information.

10. The apparatus according to claim 1, wherein the produced data comprises at least one of images, videos, time series data, or patterns.

11. The apparatus according to claim 1, wherein the neural network comprises at least one of a convolutional neural network, a recurrent neural network, a long short-term memory, a multi layer perceptron, a fully connected neural network, a transformer neural network, a graph neural network, or a reinforcement learning based neural network.

12. The apparatus according to claim 1, wherein the radio channel comprises a cellular radio channel.

13. The apparatus according to claim 1, wherein the at least one wireless data producing device comprises an internet of things, IoT, device.

14. A method, comprising:
obtaining, by an apparatus, data produced by at least one wireless data producing device, the produced data having been transferred over a block error-introducing radio channel, thereby causing information to be lost from the produced data; and
reconstructing, by the apparatus, the lost information,
wherein the reconstructing of the lost information comprises applying a neural network to the obtained data, the neural network being executable to utilize at least one of temporal or spatial correlation information related to the produced data in the reconstruction of the lost information.

15. A non-transitory computer readable medium comprising instructions, which when executed by an apparatus, cause the apparatus to perform at least the following:
obtain data produced by at least one wireless data producing device, the produced data having been transferred over a block error-introducing radio channel, thereby causing information to be lost from the produced data; and
reconstruct the lost information, wherein the reconstruction of the lost information comprises applying a neural network to the obtained data, the neural network being executable to utilize at least one of temporal or spatial correlation information related to the produced data in the reconstruction of the lost information.

16. The method according to claim 14, further comprising:
obtaining location information of the introduced block errors, wherein the neural network is further executable to utilize the obtained location information of the introduced block errors in the reconstruction of the lost information.

17. The method according to claim 14, further comprising:
evaluating accuracy of the performed reconstruction of the lost information; and
in response to the evaluated accuracy falling below a given threshold or rising above the given threshold, instructing a network node device responsible for forwarding the produced data to increase or decrease, respectively, a number of reforwardings of the produced data.

18. The method according to claim 17, wherein the instructing of the network node device to increase or decrease the number of the reforwardings is independently for at least one of a transport layer, a radio link control layer, or a medium access control layer of the radio channel.

19. The non-transitory computer readable medium of claim 15, wherein, the instructions, when executed by the apparatus, cause the apparatus to obtain location information of the introduced block errors, wherein the neural network is further executable to utilize the obtained location information of the introduced block errors in the reconstruction of the lost information.

20. The non-transitory computer readable medium of claim 15, wherein, the instructions, when executed by the apparatus, cause the apparatus to:
evaluate accuracy of the performed reconstruction of the lost information; and
in response to the evaluated accuracy falling below a given threshold or rising above the given threshold, instruct a network node device responsible for forwarding the produced data to increase or decrease, respectively, a number of reforwardings of the produced data.
